(19) United States
(12) Patent Application Publication
(10) Pub. No.: US 2002/0195778 A1
(43) Pub. Date: Dec. 26, 2002

(54) Seal

(76) Inventors: Hans-Rainer Zerfass, Taunusstein (DE); Armin Diez, Lenningen (DE)

Correspondence Address: Mr. Edward J. Timmer, Walnut Woods Center, 5955 W. Main Street, Kalamazoo, MI, 49009, US

(21) Appl. No.: 10/156,644

(22) Filed: May 24, 2002

(30) Foreign Application Priority Data
May 26, 2001 (DE) 101 25 777.5

(51) Int. Cl. F16J 3/00

(52) U.S. Cl. 277/628

(57) ABSTRACT

In order to produce a seal for sealing a clearance gap between two electrically conductive components that requiring sealing, and in particular, between two components of a composite block of fuel cells, whilst electrically insulating the components which are to be sealed, and which exhibits adequate fluid imperviousness and has an adequate electrically insulating effect even at high operational temperatures and over a long period of operation, it is proposed that the seal should comprise at least one sealing element which comprises a ceramic material, wherein the seal is of annular form and comprises at least one seating surface for at least one of the components requiring sealing and wherein said surface is at least partially aligned substantially parallel to or inclined to the ring-axis of the seal.

The present disclosure relates to the subject matter disclosed in German Patent Application No. 101 25 777. 5 of May 26, 2001, the entire specification of which is incorporated herein by reference.

The present invention relates to a seal for sealing a clearance gap between two electrically conductive components that require sealing, and in particular, between two components of a composite block of fuel cells, whilst electrically insulating the components which are to be sealed.

Such seals for sealing two components that need to be sealed in electrically insulating manner in a composite block of fuel cells are known from the state of the art.

In particular, it is known to produce such a seal from a glass solder.

Such a glass solder is described in EP 0 907 215 Al for example.

If such a glass solder seal is used at comparatively high operational temperatures such as prevail, for example, in a high temperature fuel cell (for example, approximately 800° C.), then there is the disadvantage, inter alia, that the glass solder exhibits a comparatively high electrical conductivity at such an operational temperature so that adequate electrical insulation between the electrically conductive components requiring sealing can no longer be ensured and, in consequence, the efficiency of the fuel cell will decline. Moreover, the sealing effect produced by the glass solder seal will not be ensured over a sufficiently long operational period of the seal due to the recrystallisation of the glass solder which sets-in after a certain period of operation.

Consequently, the object of the present invention is to provide a seal of the type mentioned hereinabove, which will exhibit adequate imperviousness to fluids and an adequate electrically insulating effect even at high operational temperatures and over a long period of operation.

In accordance with the invention, this object is achieved in the case of a seal incorporating the features of the preamble of claim 1 in that the seal comprises at least one sealing element which comprises a ceramic material and wherein the seal is of annular form and comprises at least one seating surface for at least one of the components requiring sealing, and wherein said surface is at least partially aligned substantially in parallel with or inclined to the ring-axis of the seal.

Due to the use of a sealing element consisting of a ceramic material, the effect is achieved that the effective electrical insulation of the seal is maintained over long operational periods even at high operational temperatures.

Moreover, the ceramic material is substantially stable in shape even at high operational temperatures so that the fluid imperviousness of the seal will also be ensured.

Due to the fact that the seal is annular in shape and that at least one of the seating surfaces for the components requiring sealing is aligned substantially in parallel with or inclined to the ring-axis of the seal, the effect is achieved that the pressure, with which the relevant component is pressed against the seating surface of the seal, can be selected to be at least partially independent of an external clamping force with which the components requiring sealing are clamped against one another.

In particular, it is possible in this manner to obtain sufficient pressure between the component requiring sealing and the seal if the seal is installed as a secondary force connection.

It should be understood hereby that a seating surface aligned such that it is inclined to the ring-axis is a seating surface which is inclined at an acute angle relative to the ring-axis, i.e. it is aligned such that it is neither perpendicular to nor parallel with the ring-axis.

Preferably, the at least one seating surface for at least one of the components requiring sealing is aligned substantially parallel to the ring-axis of the seal.

Furthermore, in a preferred embodiment of the seal, provision is made for at least one seating surface for at least one of the components requiring sealing to be arranged on the sealing element.

Since, in general, ceramic materials can only withstand comparatively small tensional- and bending loads, provision is advantageously made for the sealing element to be subjected to a compressive force in the operational state of the seal so as to ensure adequate pressure on the seating surface of the seal.

In the operational state of the seal, the sealing element is preferably subjected to a compressive force which is substantially independent of an external clamping means for the components requiring sealing.

A very high level of fluid imperviousness of the seal in every operational state, and in particular, when being heated up to the operational temperature and whilst being cooled down from the operational temperature to room temperature, will be achieved if the sealing element is subjected to a compressive force even at room temperature.

In a preferred embodiment of the seal in accordance with the invention, provision is made for the sealing element to comprise at least one curved section.

In particular, provision may be made for the sealing element to be a closed annular element.

In order to simplify the manufacture and assembly of the seal, provision is preferably made for the sealing element to be formed in one piece.

The material used for the sealing element may, for example, be a magnesium silicate, and in particular, forsterite, or an oxide ceramic, for example, an aluminium oxide or a zirconium oxide or a mixture thereof.

Preferably, a ceramic material is used which has an average co-efficient of linear thermal expansion of at least approximately 6·10⁻⁶ K⁻¹, preferably of at least approximately 9·10⁻⁶ K⁻¹ in the temperature range from room temperature (20° C.) up to the operational temperature of the seal (for example, 800° C.).

In a preferred embodiment of the seal in accordance with the invention, provision is made for the sealing element to be subjected to a compressive force in the operational state of the seal whereby said force is directed from an outer face of the sealing element which is remote from the ring-axis to an inner face of the sealing element which faces the ring-axis.

Hereby, provision may be made for the outer face of the sealing element to be curved such that it is at least partially convex and/or for the inner face of the sealing element to be curved such that it is at least partially concave.

In order to ensure that the components requiring sealing are securely separated from one another in every operational state, provision may be made for the sealing element to be provided with a projection which extends in the longitudinal direction of the element and which can be disposed between the components requiring sealing in the assembled state of the seal.

In order to ensure adequate pressure on the seating surface of the seal independently of the configuration of the components requiring sealing, provision may be made for the seal to comprise a clamping element which subjects the sealing element to a compressive force in the operational state of the seal.

In particular, provision may be made for the sealing element to comprise an at least partially convexly curved outer face and for the clamping element to abut the outer face in the operational state of the seal.

The compressive force that is exerted by the clamping element on the sealing element in the operational state of the seal may be produced, in particular, by making the average co-efficient of linear thermal expansion of the material of the sealing element be equal to or greater than the average co-efficient of linear thermal expansion of the material of the clamping element.

In this description and in the Claims, the expression _{“}average co-efficient of linear thermal expansion” of a material should be understood as meaning the average co-efficient of linear thermal expansion of the material concerned in the temperature range from room temperature (20° C.) up to the operational temperature of the seal (for example, 800° C.), insofar as a temperature range other than this is not specifically indicated.

Due to the feature indicated hereinabove, the effect is achieved that the sealing element will expand more than the clamping element when heating the seal up to the operational temperature, so that the clamping element can exert the requisite compressive force on the outer face of the sealing element.

As an alternative or in addition thereto, provision may be made for the sealing element to be a press-fit in the clamping element even at room temperature.

In particular, provision may be made for the clamping element to be shrunk onto the sealing element.

In order to shrink the clamping element onto the sealing element, the clamping element is initially heated up to a raised temperature of, for example, 300° C., whereby it will expand, and then the sealing element, which is at a lower temperature, is inserted into the clamping element. During the subsequent cooling and constriction of the clamping element, the latter will shrink onto the sealing element.

Claim 16 is directed to a group of components which comprises two electrically conductive components that are to be sealed relative to one another, and in particular, components of a composite block of fuel cells, and a seal in accordance with the invention for sealing a clearance gap between the two components requiring sealing whilst electrically insulating the components which are to be sealed.

In a preferred embodiment of the group of components, provision is made for the sealing element to comprise an at least partially convexly curved outer face and for at least one of the components requiring sealing to abut the outer face in the operational state of the seal.

In this case, the sealing element can be subjected to a compressive force in the operational state of the seal by means of the component abutting the outer face if the average co-efficient of linear thermal expansion of the material of the sealing element is equal to or greater than the average co-efficient of linear thermal expansion of the material of that component requiring sealing which abuts the outer face of the sealing element.

As an alternative or in addition thereto, provision may also be made for the sealing element to be arranged to be a press-fit, even at room temperature, in that component requiring sealing which abuts the outer face of the sealing element.

This press-fit can be produced, in particular, if the component requiring sealing which abuts the outer face of the sealing element is shrunk onto the sealing element, as has already been explained hereinabove in connection with a clamping element for the seal.

Preferably, both of the components requiring sealing abut the outer face of the sealing element.

As an alternative thereto, provision may also be made for the sealing element to comprise an at least partially concavely curved inner face and for the other one of the components requiring sealing to abut the inner face of the sealing element.

In this case, it is advantageous for the achievement of a high level of fluid imperviousness in every operational state of the seal, if the material of the sealing element has an average co-efficient of linear expansion which is equal to or smaller than the average co-efficient of linear thermal expansion of the material of the component abutting the inner face of the sealing element and if it is equal to or larger than the average co-efficient of linear expansion of the material of the component abutting the outer face of the sealing element. In this manner, the effect can be achieved that firstly, the sealing element will be subjected to a compressive force by means of the component abutting the outer face in the operational state of the seal, and secondly, that no gap will be formed between the inner face of the sealing element and the component abutting the inner face thereof in the operational state of the seal.

In order to enable at least one of the components requiring sealing to be placed on the seating surface of the seal provided therefor in a simple manner, provision is preferably made for at least one of the components requiring sealing to comprise a passage opening and a collar which at least partially surrounds the edge of this passage opening, wherein said collar rests at least partially on the sealing element.

The group of components in accordance with the invention is suitable, in particular, for use in a composite block of fuel cells, and especially, a composite block of high temperature fuel cells.

Such a composite block of high temperature fuel cells comprises a plurality of high temperature fuel cell units which have an operational temperature of up to 950° C. and can be made to function, without an external reformer, directly by a fuel gas containing hydrocarbons, such as, for example, methane or natural gas or, as an alternative thereto, when using an external reformer, by means of a diesel- or petroleum fuel.

In a preferred embodiment of such a composite block of fuel cells, provision is made for the ring-axis of the seal to be aligned substantially parallel to the direction of stacking in which the fuel cell units of the composite block of fuel cells are stacked.

Furthermore, the seal is advantageously arranged in the composite block of fuel cells in such a manner that a fluid, for example, a fuel gas or exhaust gas or an oxidising agent flows through the ring-passage-opening of the seal during the operation of the composite block of fuel cells, whereby the annular seal forms a guide for the fluid flowing through the seal.

Further features and advantages of the invention form the subject matter of the subsequent description and the graphical illustration of the exemplary embodiments. In the drawings:

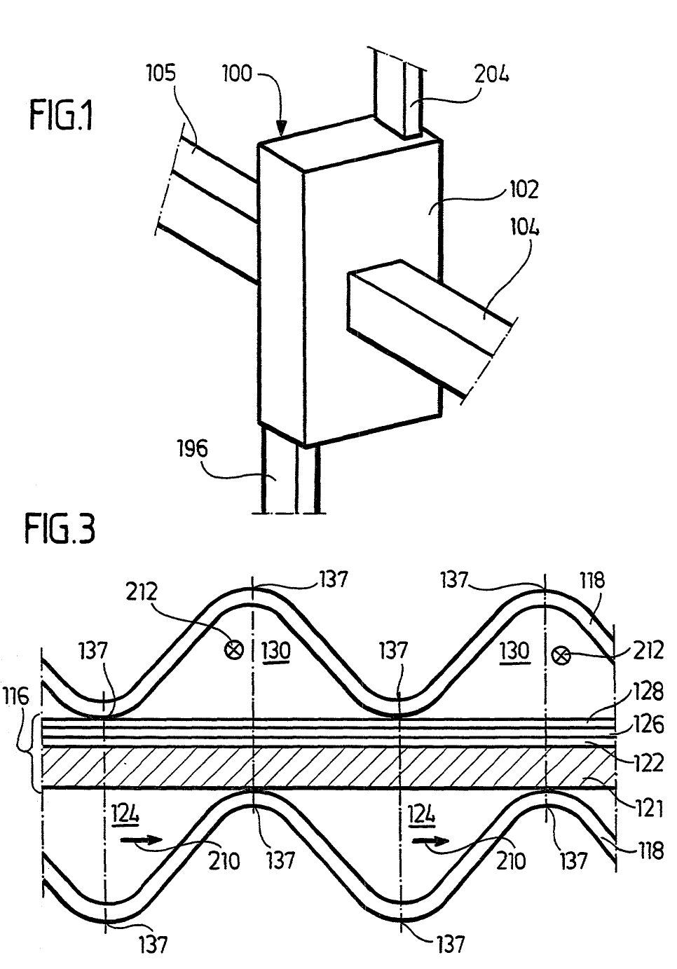

FIG. 1 shows a perspective, schematic illustration of a fuel cell device;

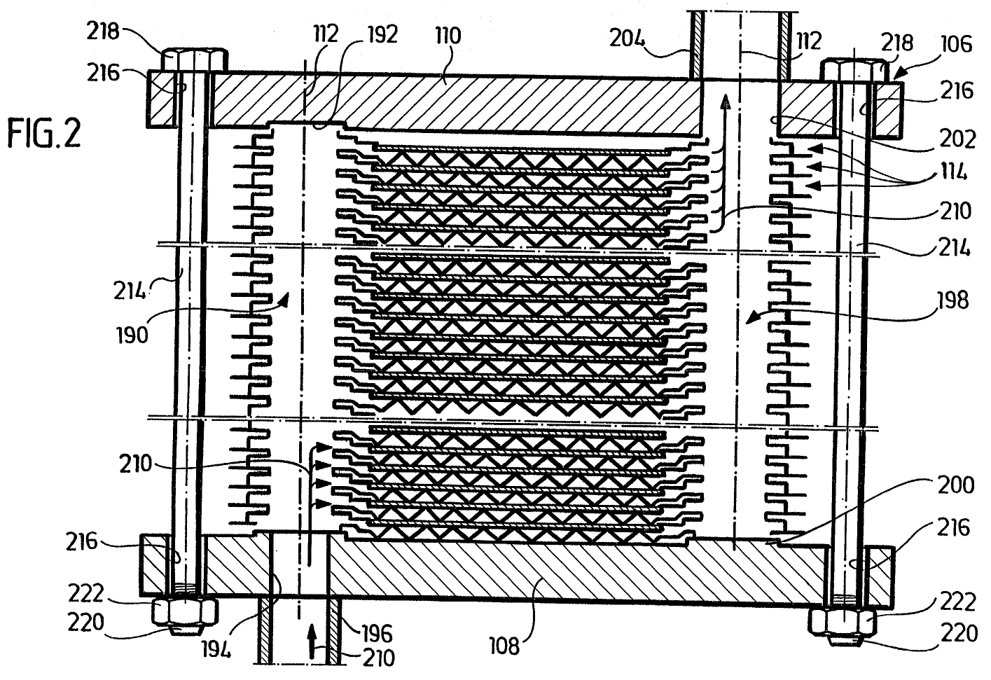

FIG. 2 a schematic longitudinal section through a composite block of fuel cells arranged in the housing of the fuel cell device shown in FIG. 1;

FIG. 3 a schematic longitudinal section through a cathode-anode-electrolyte-unit and the contact plates adjoined thereto;

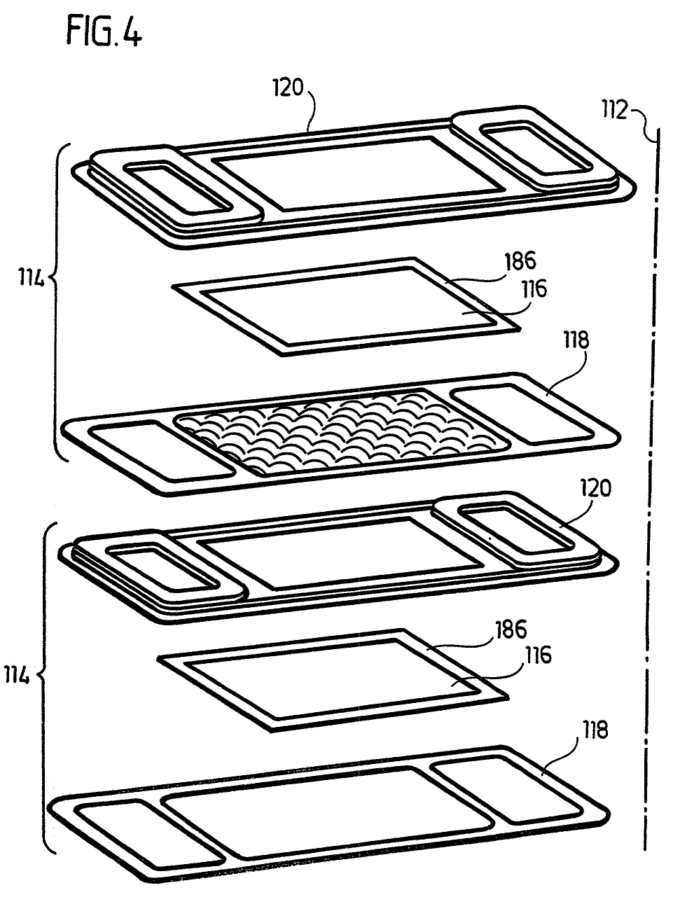

FIG. 4 a perspective, schematic, exploded illustration of two fuel cell units of the composite block of fuel cells shown in FIG. 2 that succeed one another in the direction of the stack;

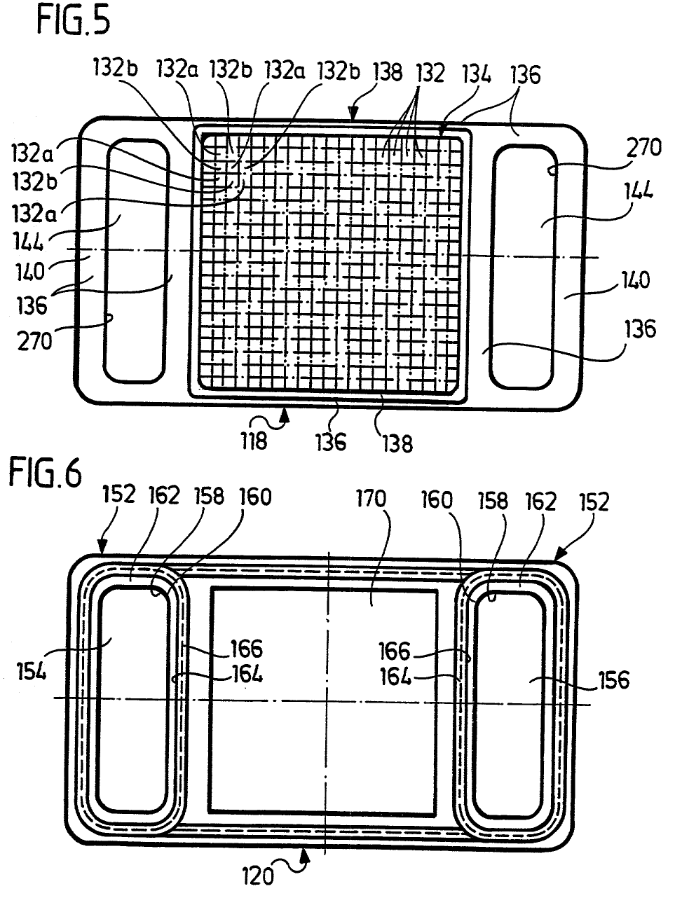

FIG. 5 a schematic top view of a contact plate of one of the fuel cell units shown in FIG. 4;

FIG. 6 a schematic top view of a fluid guidance frame of one of the fuel cell units shown in FIG. 4;

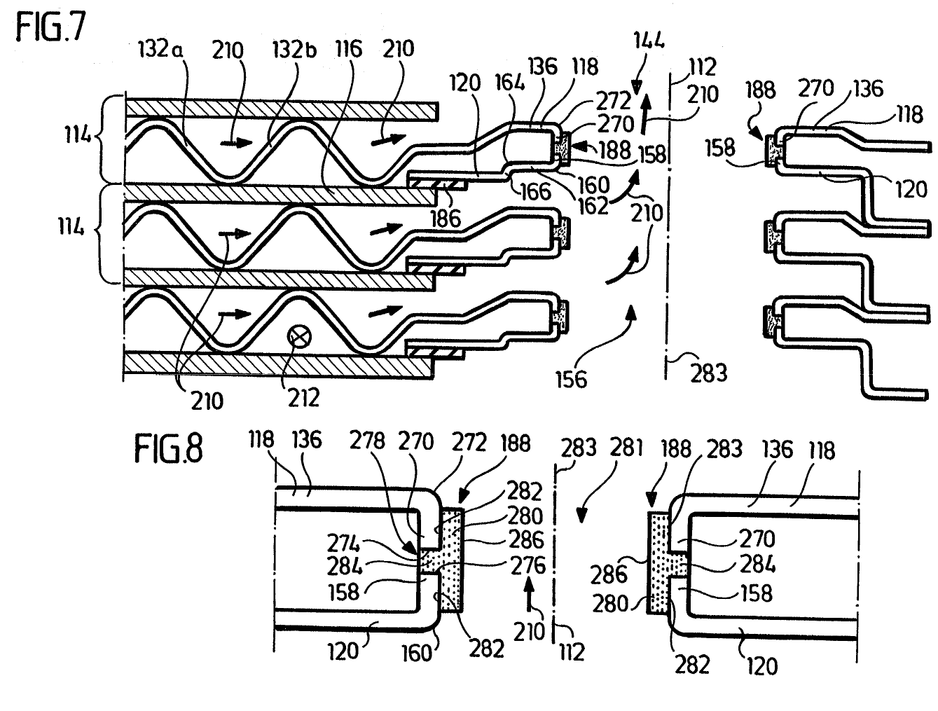

FIG. 7 the right-hand part of a schematic longitudinal section through three fuel cell units of the composite block of fuel cells shown in FIG. 2 that succeed one another in the direction of the stack, wherein a fluid guidance frame of one fuel cell unit rests on the contact plate of a neighbouring fuel cell unit via a seal comprising an annular sealing element of ceramic;

FIG. 8 a schematic section through the seal shown in FIG. 7;

FIG. 9 a top view of a portion of a curved section of the seal shown in FIG. 7;

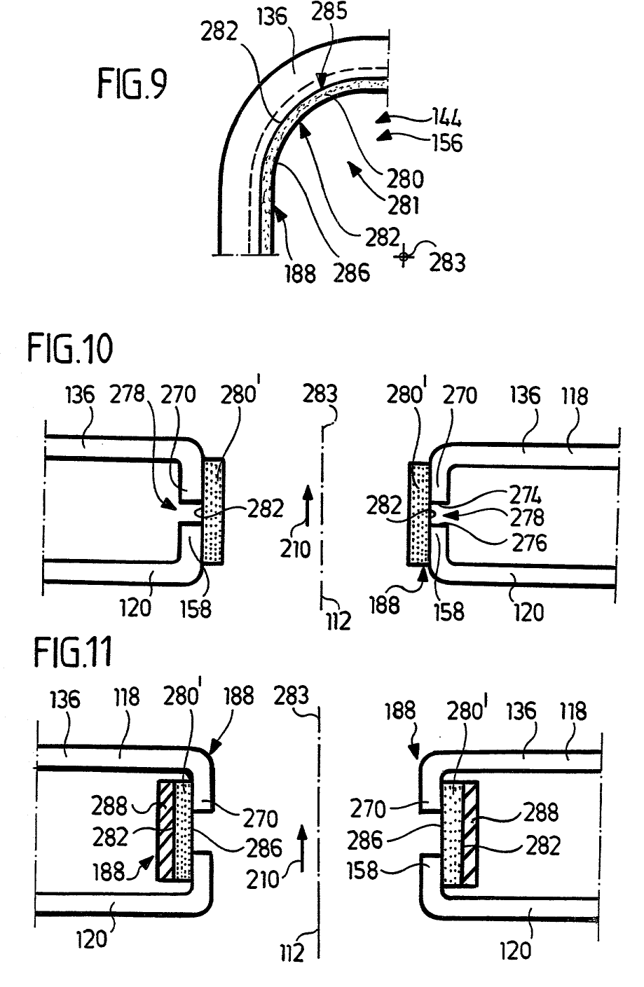

FIG. 10 a schematic section through a second embodiment of the seal;

FIG. 11 a schematic section through a third embodiment of the seal;

FIG. 12 a schematic section through a fourth embodiment of the seal;

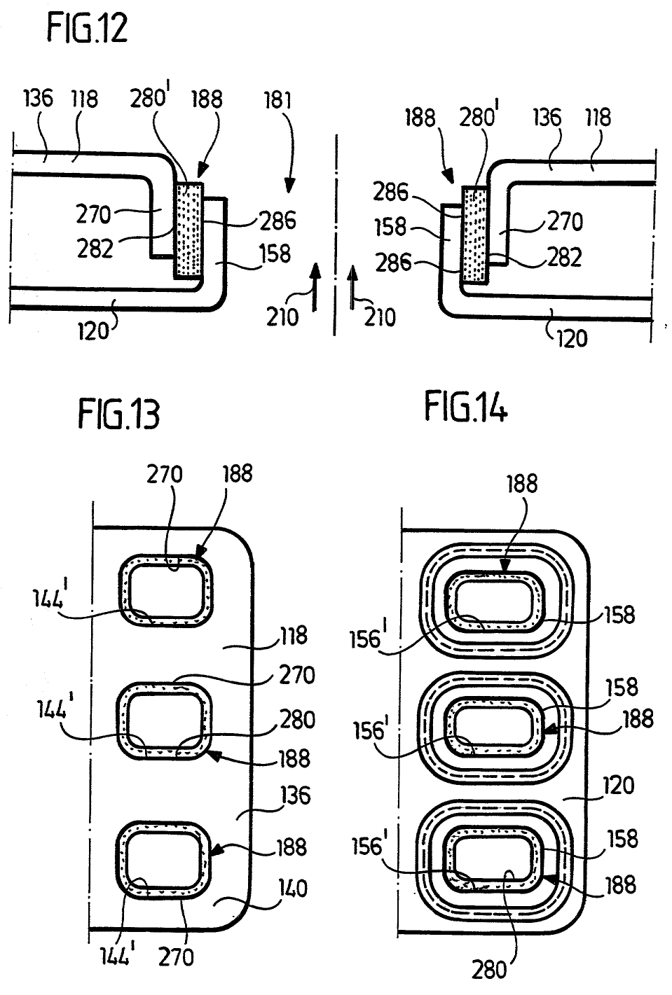

FIG. 13 a schematic top view of a portion of a contact plate comprising a plurality of passage openings per gas channel; and

FIG. 14 a schematic top view of a portion of a fluid guidance frame comprising a plurality of passage openings per gas channel.

Similar or functionally equivalent elements are designated by the same references in each of the Figures.

A fuel cell device that is illustrated in FIGS. 1 to 9 and bears the general reference 100 comprises a housing 102 (see FIG. 1) which is substantially in the shape of a cuboid and into which there extends an oxidizing agent supply line 104 via which an oxidizing agent, for example, air or pure oxygen, is supplied to the interior of the housing 102.

Furthermore, there extends from the housing 102 an oxidizing agent extraction line 105 through which excess oxidizing agent is extractable from the interior of the housing 102.

As is illustrated in FIG. 2, there is disposed in the interior of the housing 102, a composite block of fuel cells which bears the general reference 106 and which comprises a lower end plate 108, an upper end plate 110 and a plurality of fuel cell units 114 that are located between the lower end plate 108 and the upper end plate 110 and succeed one another in the direction of the stack 112.

As can best be seen from FIG. 4 which is a perspective exploded view of two fuel cell units 114 that succeed one another in the direction of the stack 112, each of the fuel cell units 114 comprises a substantially plate-shaped cathode-anode-electrolyte-unit 116 (referred to hereinafter for short as a KAE-unit), which is held between a contact plate 118 and a fluid guidance frame 120.

As is illustrated purely schematically in FIG. 3, the KAE-unit 116 comprises a gas-pervious, electrically conductive carrier layer 121, which, for example, may be in the form of a net of metallic material through the meshes of which a fuel gas can pass from a fuel gas chamber 124 bordering the carrier layer 121.

Furthermore the KAE-unit 116 comprises a plate-shaped anode 122 that is arranged on the carrier layer 121 and consists of an electrically conductive ceramic material which is porous so as to enable the fuel gas to pass through the anode 122 from the fuel gas chamber 124 to the electrolyte 126 located adjacent to the anode 122.

The fuel gas used here may be in the form of pure hydrogen or a mixture of gases containing hydrocarbons.

The electrolyte 126 is preferably in the form of a solid electrolyte.

A plate-shaped cathode 128 consisting of an electrically conductive ceramic material borders the electrolyte 126 on the opposite side thereof from the anode 122, said cathode being porous so as to enable an oxidizing agent, for example, air or pure oxygen, to pass from an oxidizing agent chamber 130 bordering the cathode 128 to the electrolyte 126.

When the fuel cell device 100 is in operation, the KAE-unit 116 in each fuel cell unit 114 has a temperature of approximately 800° C. for example, at which temperature the electrolyte 126 is conductive for oxygen ions. The oxidizing agent from the oxidizing agent chamber 130 absorbs electrons at the anode 122 and expels bivalent oxygen ions to the electrolyte 126, said ions then wandering through the electrolyte 126 to the anode 122. At the anode 122, the fuel gas from the fuel gas chamber 124 is oxidized by the oxygen ions from the electrolyte 126 and thereby donates electrons to the anode 122.

The contact plates 118 serve for removing those electrons that have been freed by the reaction at the anode 122 from the anode 122 via the carrier layer 121 i.e. for supplying the electrons needed for the reaction at the cathode 128 to the cathode 128.

To this end, each of the contact plates 118 consists of a highly electrically conductive metal sheet, which (as can best be seen from FIG. 5) is provided with a plurality of contact elements 132, which, for example, are in the form of mutually adjacent projections and depressions each having a quadratic horizontal projection so that the contact field 134 of the contact plate 118 that is formed from the contact elements 132 has the structure of a corrugated sheet having corrugations in two mutually perpendicular directions.

Each of the contact elements 132 has a central contact region 137 via which it is in electrically conductive contact with an adjacent KAE-unit 116.

The cathode-side contact elements 132b of the contact plates 118 are in electrically conductive point-contact with the cathode 128 of the KAE-unit 116 appertaining to a neighbouring fuel cell unit 114 so that electrons can pass from the contact plate 118 to the cathode 128. In this manner, the contact plates 118 enable the charge between the anodes 122 and the cathodes 128 to be equalised in the direction 112 in which the successive KAE-units 116 are stacked.

The contact plates 118 disposed at the ends of the composite block of fuel cells 106 are connected to an external circuit so as to tap off the electrical charges occurring on these edge-located contact plates 118.

As can best be seen from the top view of FIG. 5, the rectangular contact field 134 of each contact plate 118 that is provided centrally with the contact elements 132 is surrounded by a flat flange region 136 which forms the outer rim of the contact plate 118.

The lower face of the KAE-unit 116 rests on the upper face of the flange region 136 in the region of the narrow longitudinal sides 138 of the flange region 136.

The broad side regions 140 of the flange region 136 each comprise a passage opening 144 which enables the passage of the fuel gas that is to be supplied to the fuel cell units 114 or that of the exhaust gas that is to be removed from the fuel cell units 114.

Each of the contact plates 118 is in the form of a sheet-like member which is formed from a substantially flat, substantially rectangular sheet layer by a stamping process and/or a deep-drawing process and wherein the passage openings 144 are formed by stamping-out or cutting-out processes.

The fluid guidance frames 120 are also in the form of a sheet-like member which consists of a substantially flat, substantially rectangular sheet layer.

As can best be seen from FIG. 6, the end regions of each of the fluid guidance frames 120 comprise passage openings corresponding to the passage openings 144 in the contact plates, namely a fuel gas passage opening 154 and an exhaust gas passage opening 156.

As can be seen from FIG. 6, each of the fluid guidance frames 120 comprises, between the passage openings 154, 156, a substantially rectangular, central passage opening 170 for the passage of the contact elements 132 of the contact plate 118 of a neighbouring fuel cell unit 114.

As can best be seen from FIGS. 6 and 7, each of the passage openings 154, 156 in a fluid guidance frame 120 is surrounded by a collar 158 that extends in the direction of the stack 112, a flange region 162 which extends away from the passage opening perpendicularly relative to the direction of the stack 112 and adjoins a bending-line 160 of the collar 158, and a channel wall region 166 that is aligned in parallel with the direction of the stack 112 and adjoins a bending-line 164 of the flange region 162.

As can be seen from FIGS. 7 and 8, each of the contact plates 118 is provided with a collar 270 which is formed by bending the flange regions 136 along a bending-line 272 and which extends downwardly from the flange region 136 in parallel with the direction of the stack 112 and surrounds the respective passage opening 144 of the relevant contact plate 118.

As can best be seen from FIG. 8, the respective collars 270 and 158 of a contact plate 118 and of a fluid guidance frame 120 adjacent thereto are aligned such that they are flush with one another and are mutually spaced in the direction of the stack 112 in such a manner that a clearance gap 278 is left between the lower edge 274 of the collar 270 and the upper edge 276 of the collar 158, said clearance gap being sealed by means of an annular gas channel seal 188 having a ring-axis 283.

As can best be seen from FIG. 8, the gas channel seal 188 comprises a sealing element 280 which is in the form of an annular closed sleeve that surrounds a ring-passage-opening 281 through the gas channel seal 188.

The sealing element 280 has an outer face 282 which is remote from the ring-passage-opening 281, the outer face of the collar 270 of the contact plate 118 abutting closely against the upper region of said outer face whilst the outer face of the collar 158 of the fluid guidance frame 120 abuts closely against the lower region thereof.

Furthermore, the outer face 282 of the sealing element 280 comprises a projection 284 which extends around the periphery of the sealing element 280 and is inserted into the clearance gap 278 thereby separating the lower edge 274 of the collar 270 from the upper edge 276 of the collar 158.

As can be seen from the top view of the gas channel seal 188 in FIG. 9, the sealing element 280 comprises a curved section 285 in the corner regions of the respective passage openings 144, 156, wherein the outer face 282 of the sealing element 280 is convexly curved whereas the inner face 286 of the sealing element 280 facing the ring-passage-opening 281 is concavely curved.

The sealing element 280 is formed from a ceramic material which remains solid and stable in shape even at the operational temperature of the fuel cell device 100 of 800° C. for example, and it also exhibits a high electrical resistance.

A magnesium silicate, and in particular, forsterite (as defined in DIN EN 60672: C250) may, for example, be used as the ceramic material for the sealing element 280. Forsterite has an average co-efficient of linear thermal expansion α of approximately 10·10⁻⁶ K⁻¹ to approximately 11·10⁻⁶ K⁻¹ in the temperature range from 20° C. to 600° C. The specific electrical resistance of forsterite is approximately 10⁵ Ωm at a temperature of 600° C.

This material may, for example, be obtained from the company Sembach Technische Keramik, Oskar-Sembach-Straβe 15, 91207 Lauff an der Pegnitz, Germany.

As an alternative or in addition thereto, an aluminium oxide, and in particular, the aluminium oxide referred to as C799 in DIN EN 60672 could also be used as the ceramic material for the sealing element 280. The aluminium oxide C799 has an average co-efficient of linear expansion α of approximately 7·10⁻⁶ K⁻¹ to approximately 8·10⁻⁶ K⁻¹ in the range from 20° C. to 600° C. The specific electrical resistance of this material amounts to approximately 10⁶ Ωm at a temperature of 600° C.

This material may, for example, be obtained under reference _{“}A99” from the aforementioned company Sembach Technische Keramik.

As an alternative or in addition to the aforementioned materials, a zirconium oxide, and in particular, a zirconium oxide that is partially stabilised by the admixture of small quantities of yttrium oxide for stabilising the crystal structure, may also be used as the ceramic material for the sealing element 280.

The partially stabilised zirconium oxide has an average co-efficient of linear thermal expansion α of approximately 10·10⁻⁶ K⁻¹ to approximately 12.5·10⁻⁶ K⁻¹ in the range from 30° C. to 1000° C. The specific electrical resistance of this material amounts to approximately 10³ Ωm to approximately 10⁶ Ωm at a temperature of 600° C.

The sealing element 280 can be manufactured from the aforementioned ceramic materials, for example, by means of a ceramic injection moulding process. In this method, a ceramic powder of the desired material is plasticised with an organic binder system and processed in a high pressure injection moulding machine for synthetic materials. The organic binding agent is removed following the moulding process. The moulded article produced by the injection moulding process is then sintered and subjected to further processing should this be necessary.

The sealing element 280 is a press-fit in the collar 270 of the contact plate 118 and in the collar 158 of the fluid guidance frame 120, whereby the sealing element 280 is subjected to a compressive force aligned with the ring-axis 283 of the sealing element 280 by virtue of the collar 270 and the collar 158.

The press-fit of the sealing element 280 in the collars 270 and 158 is achieved in that, during the assembly of the fuel cell device 100, the flange region 136 of the contact plate 118 and that of the fluid guidance frame 120 are heated to a raised temperature of, for example, 300° C., in order to enlarge the respective passage openings 144 and 154, 156 which are surrounded by the respective collars 270 and 158. The cooler sealing element 280, which, for example, is at room temperature (20° C.), is inserted into the collars 270 and 158 that have been widened by thermal expansion in this manner. During the subsequent cooling of the contact plate 118 and the fluid guidance frame 120, the collars 270 and 158 then shrink onto the outer face 282 of the sealing element 280 so that a compressive force will be applied to the sealing element 280 even at room temperature.

Due to the fact that the surfaces of the outer faces of the collars 270 and 158 are pressed closely against the outer face 282 of the sealing element 280, a reliable, gas-tight and electrically insulating sealing of the clearance gap 278 that is covered by the sealing element 280 is thus ensured.

The flange region 136 of the contact plate 118 and of the fluid guidance frame 120 are preferably manufactured from a heat resistant steel.

For example, a ferrite steel having the stock number 1.4742 (in accordance with SEW 470) can be used as the material for these components, this material having the following composition:

0,08% age parts by weight of carbon, 1,3% age parts by weight of silicon, 0,7% age parts by weight of manganese, 18% age parts by weight of chrome, 1% age part by weight of aluminium, the remainder being iron. Such a steel has good temperature stability characteristics up to a temperature of 1000° C. The average co-efficient of linear thermal expansion of this material amounts to approximately 12·10⁻⁶ K⁻¹ between 20° C. And 600° C. And is thus approximately the same as the average co-efficient of linear thermal expansion of partially stabilised zirconium oxide in this temperature range. If the sealing element 280 is made of partially stabilised zirconium oxide and the contact plate 118 and the fluid guidance frame are made from the steel 1.4742, then, during the heating of the fuel cell device from room temperature up to the operational temperature of approximately 800° C., the sealing element 280 and the collars 270 and 158 will expand by substantially the same amount, so that the pre-tensioning of the sealing element 280 by the collar 270 and 158 that exists at room temperature will remain substantially unaltered at the operational temperature of the gas channel seal 188 this thereby ensuring that the outer faces of the collars 270, 158 will be pressed firmly against the outer face of the sealing element 280 whence the gas-imperviousness of the gas channel seal 188 will also be ensured.

If, instead of the partially stabilised zirconium oxide, forsterite or aluminium oxide C799 are used, then the average co-efficient of linear thermal expansion of the sealing element 280 will be smaller than the average co-efficient of linear thermal expansion of the collars 158, 270. In this case, the collars 270, 158 will expand to a greater extent than the sealing element 280 during the process of heating the arrangement up to the operational temperature so that the compressive force effective on the sealing element 280 will be smaller in the operational state of the gas channel seal 188 than it is at room temperature. In this case however, the bias pressure effective on the sealing element 280 at room temperature is selected to be so large that even after a reduction of the compressive force due to the differing thermal expansions of the sealing element 280 and the collars 270, 158, the pressure, with which the outer faces of the collars 270, 158 are pressed against the outer face 282 of the sealing element 280 at the operational temperature, will still be sufficiently high as to ensure the requisite gas-imperviousness of the gas channel seal 188.

If the sealing element 280 is formed from a ceramic material which has a greater average co-efficient of linear thermal expansion than the material of the collars 270, 158, then the compressive force effective on the sealing element 280 during the process of heating the arrangement up to the operational temperature will in fact increase.

In this case, the collars 270, 158 could simply rest on the sealing element at room temperature without applying pressure thereto or they could even be spaced therefrom. During the process of heating the arrangement up to the operational temperature, the sealing element 280 will then expand to a greater extent than the collars 270, 158 so that the outer faces of the collars 270, 158 will be pressed against the outer face 282 of the sealing element 280 at the pressure needed to ensure satisfactory gas imperviousness.

In this case, the collars 270, 158 do not need to be shrunk onto the sealing element 280 during the manufacture of the fuel cell device 100; but rather, it suffices to merely lodge the sealing element 280 on the collars 270, 158.

As can best be seen from FIGS. 4 and 7, each KAE unit 116 is provided with a gas-tight, electrically insulating fuel gas chamber seal 186 at the edge of the upper face thereof facing the fluid guidance frame 120 of the same fuel cell unit 114, whereby said seal projects laterally beyond the KAE-unit 116.

This fuel gas chamber seal 186 may, for example, comprise a flat seal consisting of mica.

In particular, this flat seal may comprise laminated mica, preferably phlogopite, or a mica paper manufactured with the aid of a paper making machine.

The fuel cell units 114 of the composite block of fuel cells 106 are stacked upon one another in the direction of stacking 112 in such a manner that the cathodeside contact elements 132b of each contact plate 118 will extend through the passage opening 170 in the fluid guidance frame 120 of the respective fuel cell unit 114 located therebelow to the cathode of the KAE-unit 116 of the fuel cell unit 114 located therebelow and rest in electrically conductive contact thereon.

The collar 270 of the flange region 270 of each contact plate 118 thereby rests on the collar 158 of the fluid guidance frame 120 of the respective fuel cell unit 114 located therebelow via the gas channel seal 188.

The end region 152 of each fluid guidance frame 120 surrounding the fuel gas passage opening 154 forms a fuel gas guidance region. The end region 152 of each fluid guidance frame 120 surrounding the exhaust gas passage opening 156 forms an exhaust gas guidance region.

As can best be seen from the sectional illustration of FIG. 2, the mutually successive fuel gas guidance regions of the fluid guidance frames 120 in the direction of stacking 112 together form a fuel gas channel 190 which extends in parallel with the direction of stacking 112 and discharges at the upper end thereof into a recess 192 in the lower face of the upper end plate 110.

A fuel gas supply opening 194, which penetrates the lower end plate 108 of the composite block of fuel cells 106 co-axially relative to the fuel gas channel 190, opens into the lower end of the fuel gas channel 190.

To the end of the fuel gas supply opening 194 remote from the fuel gas channel 190, there is connected a fuel gas supply line 196 which passes through the housing 102 of the fuel cell device 100 in gas-tight manner and is connected to a (not illustrated) fuel gas supply which supplies a fuel gas, for example, a gas containing hydrocarbons or pure hydrogen, to the fuel gas supply line 196.

As can likewise be seen from FIG. 2, the exhaust gas guidance regions of the fluid guidance frames 120 extending successively in the direction of stacking 112 together form an exhaust gas channel 198 which is aligned in parallel with the direction of stacking 112 and, at the lower end thereof, is closed by a projection 200 that is provided on the upper face of the lower end plate 108 of the composite block of fuel cells 106.

At the upper end thereof, the exhaust gas channel 198 discharges into an exhaust gas extraction opening 202 which is co-axial therewith and penetrates the upper end plate 110 of the composite block of fuel cells 106 whilst the end thereof remote from the exhaust gas channel 198 is connected to an exhaust gas extraction line 204.

The exhaust gas extraction line 204 is fed in gas-tight manner through the housing 102 of the fuel cell device 100 and connected to a (not illustrated) exhaust gas processing unit.

When the fuel cell device 100 is in operation, the fuel gas flows through the fuel gas supply line 196 and the fuel gas supply opening 194 into the fuel gas channel 190 and from there, it is distributed through the intermediary spaces between the contact plates 118 and the respective fluid guidance frames 120 appertaining to the same fuel cell unit 114 to the fuel gas chambers 124 of the fuel cell units 114, which are respectively enclosed by the contact plate 118, the fluid guidance frame 120 and the KAE-unit 116 of the relevant fuel cell unit 114.

The fuel gas is at least partially oxidised at the anode 122 of the respective KAE-unit 116.

The product of the oxidation process (for example, water) together with excess fuel gas then exit the fuel gas chambers 124 of the fuel cell units 114 and enter the exhaust gas channel 198, from where they are removed through the exhaust gas extraction opening 202 and the exhaust gas extraction line 204 to the exhaust gas processing unit.

The oxidizing agent needed for the operation of the fuel cell device 100 (for example, air or pure oxygen) is supplied to the interior of the housing 102 through the oxidizing agent supply line 104.

In the interior of the housing 102, the oxidizing agent is distributed to the oxidizing agent chambers 130 which are formed between the fuel gas chambers 124 of the fuel cell units 114 and which are respectively enclosed by a contact plate 118 of a fuel cell unit 114 and by the fluid guidance frame 120 and the cathode 128 of the KAE-unit 116 of a neighbouring fuel cell unit 114.

The oxidizing agent enters the oxidizing agent chambers and departs therefrom through the respective intermediary spaces between a respective fluid guidance frame 120 of a fuel cell unit 114 and the contact plate 118 of the succeeding fuel cell unit 114 in the direction of stacking 112.

The excess oxidizing agent from the oxidizing agent chambers 130 of the fuel cell units 114 reaches the outlet side located opposite the inlet side for the oxidizing agent and is removed from the interior of the housing 102 of the fuel cell device 100 via the oxidizing agent extraction line 105.

The direction in which the fuel gases and the exhaust gases flow through the fuel cell device 100 is indicated in the drawings by means of single arrows 210, the direction in which the oxidizing agent flows through the fuel cell device 100 is indicated by means of double arrows 212.

In order to fix the fuel cell units 114 that succeed one another in the direction of stacking 112 together using an external clamping means, there are provided a plurality of connecting bolts 214 which penetrate the through-borings 216 in the end plates 108, 110 of the composite block of fuel cells 106 and are provided with an external thread 220 at the end thereof remote from the respective bolt head 218, a respective connection nut 222 being screwed onto said thread so that the end plates 108, 110 will be clamped between the bolt heads 218 and the connection nuts 222 whereby the requisite compressive force can be applied to the stack of fuel cell units 114 via the end plates 108, 110 (see FIG. 2).

The composite block of fuel cells 106 described hereinabove is assembled as follows:

Firstly, the individual fuel cell units 114 are assembled by arranging a respective KAE-unit 116 between a contact plate 118 and a fluid guidance frame 120 whereafter the mutually abutting flange regions 136 of the contact plates 118 and the flange region of the fluid guidance frame 120 are connected together in gas-tight manner, for example, by soldering or welding.

The composite block of fuel cells 106 is then built-up from the individual fuel cell units 114 by stacking the desired number of fuel cell units 114 in the direction of stacking 112 and a collar 270 of each respective contact plate 118 is connected to the collar 158 of the fluid guidance frame 120 of a neighbouring fuel cell unit 114 by means of a sealing element 280 which is a press-fit in these collars.

Finally, the fuel cell units 114 are clamped together by means of the end plates 108, 110 and the connecting bolts 214 and connection nuts 222 that clamp these end plates together.

A second embodiment of a fuel cell device 100 that is illustrated in FIG. 10 differs from the first embodiment described hereinabove merely in the design of the gas channel seal 188.

As can be seen from FIG. 10, the sealing element 280′ in this second embodiment does not comprise a projection extending peripherally of the outer face 282; but rather, the outer face 282 of the sealing element 280 is in the form of a continuous plane.

The requisite electrical insulating effect of the gas channel seal 188 is nevertheless maintained since the lower edge 274 of the collar 270 on the contact plate 118 and the upper edge 276 of the collar 158 on the fluid guidance frame 120 are separated from one another by the clearance gap 278. Due to the large amount of friction between the outer faces of the collars 270, 158 on the one hand, and the outer face 282 of the sealing element 280′ on the other, which is caused by the high pressure existing between these components, it is ensured that the two collars 270, 158 will not move relative to the sealing element 280′ and hence will not move relative to one another.

Due to the lack of the projection on the outer face 282 of the sealing element 280′, the sealing element 280′ of the second embodiment is more simple to manufacture and easier to work than the sealing element 280 of the first embodiment.

Otherwise, the second embodiment of a fuel cell device 100 corresponds exactly to the first embodiment in regard to the construction and functioning thereof, so that, in these respects, reference may be made to the preceding description thereof.

A third embodiment of a fuel cell device 100 that is illustrated in FIG. 11 differs from the first embodiment described hereinabove merely in regard to the design of the gas channel seal 188.

As can be seen from FIG. 11, in this embodiment, the outer faces of the collars 270, 158 do not abut the outer face 282 of the sealing element of the gas channel seal 188, but rather, the inner faces thereof abut the inner face 286 of the sealing element 280′ which is in the form of an annular closed sleeve consisting of a ceramic material.

Thus, in this configuration of the gas channel flat seal 188, the sealing element 280′ would not be subjected to compression by the collars 270, 158, but rather, to tension, this being unfavourable for a ceramic material.

This tensional loading of the sealing element 280 is therefore compensated or over-compensated by a compressive loading which is produced by means of an annular clamping sleeve 288 which surrounds the sealing element 280′ such that the inner face thereof abuts closely against the outer face 282 of the sealing element 280′.

The clamping sleeve 288 is formed, for example, from a steel which is stable at the operational temperature of the fuel cell device of approximately 800° C. The requisite compression of the sealing element 280′ by the clamping sleeve 288 is achieved in that the clamping sleeve 288 is shrunk onto the sealing element 280′ during the manufacture of the gas channel flat seal 188 and/or in that the material used for the clamping sleeve 288 has a smaller average co-efficient of linear thermal expansion than the material of the sealing element 280′.

In the case of this embodiment, the material of the collars 270, 158 should have an average co-efficient of linear thermal expansion which is at least equal to or only slightly less than the average co-efficient of linear thermal expansion of the material of the sealing element 280′ in order to prevent the formation of a gap between the inner faces of the collars 270, 158 on the one hand and the inner face 286 of the sealing element 280′ on the other when heating the gas channel seal 188 up to the operational temperature.

In the same manner as for the sealing element 280′ of the second embodiment, the sealing element 280′ of the third embodiment does not comprise a projection extending peripherally of the outer face.

Otherwise, the third embodiment of a fuel cell device 100 corresponds exactly to the first embodiment in regard to the construction and functioning thereof, so that, in these respects, reference may be made to the preceding description thereof.

A fourth embodiment of a fuel cell device 100 that is illustrated in FIG. 12 differs from the first embodiment described hereinabove merely in regard to the design of the gas channel seal 188.

As can be seen from FIG. 12, in this embodiment, only the outer face of the collar 270 of the contact plate 118 abuts the outer face 282 of the sealing element 280′; by contrast, the collar 158 of the fluid guidance frame 120 engages in the ring-passage-opening 281 of the sealing element 280′ from the lower face thereof and the inner face of said collar closely abuts the inner face 286 of the sealing element 280′.

In this embodiment, the sealing element 280′ is held in tension on the fluid guidance frame by means of the collar 158 and it is held under pressure on the contact plate 118 by the collar 270.

Here, the geometries of the components involved and the co-efficients of thermal expansion thereof are selected in such a manner that the pressure applied by the collar 270 to the contact plate 118 exceeds the tensional loading applied by the collar 159 to the fluid guidance frame 120.

In particular, provision may be made for the collar 270 on the contact plate 118 to be shrunk onto the outer face 282 of the sealing element 280′ during the process of manufacturing the gas channel seal 188.

Furthermore it is advantageous if the flange region 136 of the contact plate 118 is formed from a material which has a smaller average co-efficient of linear thermal expansion than the material of the sealing element 280′.

The material selected for the fluid guidance frame 120 is preferably a material whose average co-efficient of linear thermal expansion is at least equal to or only slightly smaller than the average co-efficient of linear thermal expansion of the material of the sealing element 280′ so as to prevent a gap from being formed between the inner face 286 of the sealing element 280′ and the inner face of the collar 158 on the fluid guidance frame 120 during the process of heating the gas channel seal 188 up to the operational temperature.

The fuel gas or the exhaust gas flows through the ring-passage-opening 281 from that side thereof from which the collar 158 abutting the inner face 286 of the sealing element 280′ engages in the sealing element 280′. In consequence, the gas will not flow directly over the seating surfaces upon which the collar 158 or the collar 270 rest on the sealing element 280′, this thereby reducing the passage of gas through the gas channel seal 188 in the possible event of leakages occurring.

In the same manner as for the sealing element 280′ of the second embodiment and that of the third embodiment, the sealing element 280′ of the fourth embodiment does not comprise a projection extending peripherally of the outer face 282 thereof.

Otherwise, the fourth embodiment of a fuel cell device 100 corresponds exactly to the first embodiment in regard to the construction and functioning thereof, so that, in these respects, reference may be made to the preceding description thereof.

A fifth embodiment of a fuel cell device 100 that is illustrated in FIGS. 13 and 14 differs from the embodiments described hereinabove merely in that each side region 140 of the flange region 136 of a contact plate 118 does not merely comprise one passage opening 144, but instead, it has a plurality, three for example, of smaller passage openings 144′ (see FIG. 13).

In a corresponding manner, the end regions of each fluid guidance frame 120 comprise a plurality, three for example, of fuel gas passage openings and exhaust gas passage openings 156′ which correspond to the passage openings 144′ in the contact plates.

Each of the passage openings in the fluid guidance frame 120 is provided with a collar 158 which is directed towards a neighbouring contact plate 118 in the manner described hereinabove.

Each of the passage openings 144′ in the contact plates 118 is provided with a collar 270 which is directed towards a neighbouring fluid guidance frame 120 in the manner described hereinabove.

In each case, a collar 270 of a contact plate 118 and a collar 158 of a fluid guidance frame 120 are connected to one another in gas-tight and electrically insulating manner by means of a gas channel seal 188 in the manner described hereinabove.

These gas channel seals may be constructed in any of the ways described hereinabove.

However, since the passage openings 144′, 156′ in the case of the fifth embodiment (when the total gas passage surface areas are the same) are smaller than the corresponding passage openings in the first to fourth embodiments, the sealing elements 280, 280′ of the gas channel seals 188 in the fifth embodiment may be smaller, and in particular, have a shorter peripheral length, than was the case in the other embodiments.

This simplifies the manufacture of these sealing elements and reduces the danger of fissures being formed in, or even total breakage of, the sealing elements.

Otherwise, the fifth embodiment of a fuel cell device 100 corresponds exactly to the previously described embodiments in regard to the construction and functioning thereof, so that, in these respects, reference may be made to the preceding description thereof.

1. A seal for sealing a clearance gap between two electrically conductive components that require sealing, and in particular, between two components of a composite block of fuel cells, whilst electrically insulating the components which are to be sealed, wherein the seal comprises at least one sealing element which comprises a ceramic material, wherein the seal is of annular form and comprises at least one seating surface for at least one of the components requiring sealing and wherein said seating surface is at least partially aligned substantially parallel to or inclined to the ring-axis of the seal.

2. A seal in accordance with claim 1, wherein a compressive force is applied to the sealing element in the operational state of the seal.

3. A seal in accordance with claim 1, wherein a compressive force is applied to the sealing element at room temperature.

4. A seal in accordance with claim 1, wherein the sealing element comprises at least one curved section.

5. A seal in accordance with claim 1, wherein the sealing element is in the form of a closed annulus.

6. A seal in accordance with claim 1, wherein the sealing element is formed in one piece.

7. A seal in accordance with claim 1, wherein a compressive force is applied to the sealing element in the operational state of the seal, said force being directed from an outer face of the sealing element which is remote from the ringaxis towards an inner face of the sealing element which faces the ring-axis.

8. A seal in accordance with claim 7, wherein the outer face of the sealing element is curved at least partially convexly.

9. A seal in accordance with claim 7, wherein the inner face of the sealing element is curved at least partially concavely.

10. A seal in accordance with claim 1, wherein the sealing element is provided with a projection extending in the longitudinal direction of the sealing element.

11. A seal in accordance with claim 1, wherein the seal comprises a clamping element which applies a compressive force to the sealing element in the operational state of the seal.

12. A seal in accordance with claim 11, wherein the sealing element comprises an at least partially convexly curved outer face and wherein the clamping element abuts the outer face in the operational state of the seal.

13. A seal in accordance with claim 11, wherein the average co-efficient of linear thermal expansion of the material of the sealing element is equal to or greater than the average co-efficient of linear thermal expansion of the material of the clamping element.

14. A seal in accordance with claim 11, wherein the sealing element is a press-fit in the clamping element.

15. A seal in accordance with claim 11, wherein the clamping element is shrunk onto the sealing element.

16. A group of components, comprising two electrically conductive components that are to be mutually sealed, and in particular, components of a composite block of fuel cells, and a seal in accordance with claim 1 which seals a clearance gap between the two components requiring sealing whilst electrically insulating the components requiring sealing.

17. A group of components in accordance with claim 16, wherein the sealing element comprises an at least partially convexly curved outer face and wherein at least one of the components requiring sealing abuts the outer face in the operational state of the seal.

18. A group of components in accordance with claim 17, wherein the average co-efficient of linear thermal expansion of the material of the sealing element is equal to or greater than the average co-efficient of linear thermal expansion of the material of the component requiring sealing that abuts the outer face of the sealing element.

19. A group of components in accordance with claim 17, wherein the sealing element is a press-fit in the component requiring sealing that abuts the outer face of the sealing element.

20. A group of components in accordance with claim 17, wherein the component requiring sealing that abuts the outer face of the sealing element is shrunk onto the sealing element.

21. A group of components in accordance with claim 17, wherein both of the components requiring sealing abut the outer face of the sealing element.

22. A group of components in accordance with claim 17, wherein the sealing element comprises an at least partially concavely curved inner face and wherein the other one of the components requiring sealing abuts the inner face of the sealing element.

23. A group of components in accordance with claim 22, wherein the material of the sealing element has an average co-efficient of linear thermal expansion which is equal to or smaller than the average co-efficient of linear thermal expansion of the material of the component abutting the inner face of the sealing element and is equal to or greater than the average co-efficient of linear expansion of the material of the component abutting the outer face of the sealing element.

24. A group of components in accordance with claim 16, wherein at least one of the components requiring sealing comprises a passage opening and a collar which at least partially surrounds the edge of this passage opening, wherein the collar rests at least partially on the sealing element.

25. A composite block of fuel cells comprising at least one group of components in accordance with claim 16.

26. A composite block of fuel cells in accordance with claim 25, wherein the ring-axis of the seal is aligned substantially parallel to the direction of stacking in which the fuel cell units of the composite block of fuel cells are stacked.

27. A composite block of fuel cells in accordance with claim 25, wherein a fluid flows through the ring-passage-opening of the seal when the composite block of fuel cells is in operation.
